(19) United States
(12) Patent Application Publication
(10) Pub. No.: US 2007/0266098 A1
(43) Pub. Date: Nov. 15, 2007

(54) System and method for emailing an entity using its non-email attributes

(76) Inventor: Raz Gordon, Hadera (IL)

Correspondence Address: Collage Analytcs LLC, 1652 48th Street, Brooklyn, NY, 11204, US

(21) Appl. No.: 11/381,731

(22) Filed: May 4, 2006

Related U.S. Application Data
(60) Provisional application No. 60/594,786, filed on May 5, 2005.

(51) Int. Cl. G06F 15/16

(52) U.S. Cl. 709/206

(57) ABSTRACT

A method and system for sending a message to an email address of a recipient by using a non-email attribute of the recipient. The non-email attribute of the recipient is sent to partner servers which maintain records of a plurality of email addresses and non-email attributes associated with each of the plurality of email addresses. One or more of the partner servers determines the email address of the recipient as being associated with the non-email attribute of the recipient, and an email message is sent to the email address of the recipient with instructions for retrieving the message.

### CROSS REFERENCE TO RELATED APPLICATION

Benefit is claimed under 35 USC §119(e)(1), to the filing date of U.S. provisional patent application No. 60/594,786, entitled “System and method for emailing an entity using its non-email attributes”, filed on May 5, 2005. The aforementioned patent application is hereby incorporated herein by reference in its entirety.

### BACKGROUND OF THE INVENTION

Email is a convenient and efficient means of communication. Setting up an email account with an email provider is largely easy and cost-free. Indeed, many email providers such as Hotmail and Gmail charge nothing for setting up email accounts. The number of email addresses worldwide has become immeasurable, with many people maintaining multiple email addresses.

Despite the ubiquity of email, researching the email address of an individual, business or other entity type, for which an email address is unknown, may not be an easy task. Unlike phone number lists and directories, email lists and directories are largely unavailable. Phone number lists and directories are generally published by regional telephone companies, which by default publish all numbers for telephone lines in service. Subscribers that choose to keep their numbers unlisted are charged special fees. However, the fragmented nature of email has resulted in a lack of similar email directories. Additionally, unlike phone numbers, people are much more likely to keep their email address secret and to only disclose it on a very limited basis, this being as a result of the threat and hassle, infamously known as “email-spamming”.

Thus there remains an inherent need for a service that enables the sending of email to a recipient without knowledge of the recipient's email address, by using the recipient's non-email attributes (e.g. a person's phone number).

### SUMMARY OF THE INVENTION

It is an object consistent with the principles of the present invention as illustrated by the preferred embodiment to provide a computerized method and system for notifying a recipient of a message via email, by using a non-email attribute of the recipient.

A sender sends a message to a central computer including the non-email attribute of the recipient but without the email address of the recipient.

The non-email attribute of the recipient is further routed to one or more partner servers. Each of the partner servers maintains records of a plurality of email addresses and one or more non-email attributes associated with each of the plurality of email addresses.

One or more of the partner servers identifies the email address of the recipient as being associated with the non-email attribute of the recipient. A message is sent to the email address of the recipient with instructions for retrieving the message of the sender.

Additional novel features and aspects of the invention are set forth in part in the description that follows, and are in part inherent and/or obvious from the description. The techniques described herein can be implemented using various software or hardware based technologies.

### BRIEF DESCRIPTION OF THE DRAWING

FIG. 1 is a network diagram of the preferred embodiment of the present invention.

### DETAILED DESCRIPTION OF THE PREFERRED EMBODIMENT OF THE PRESENT INVENTION

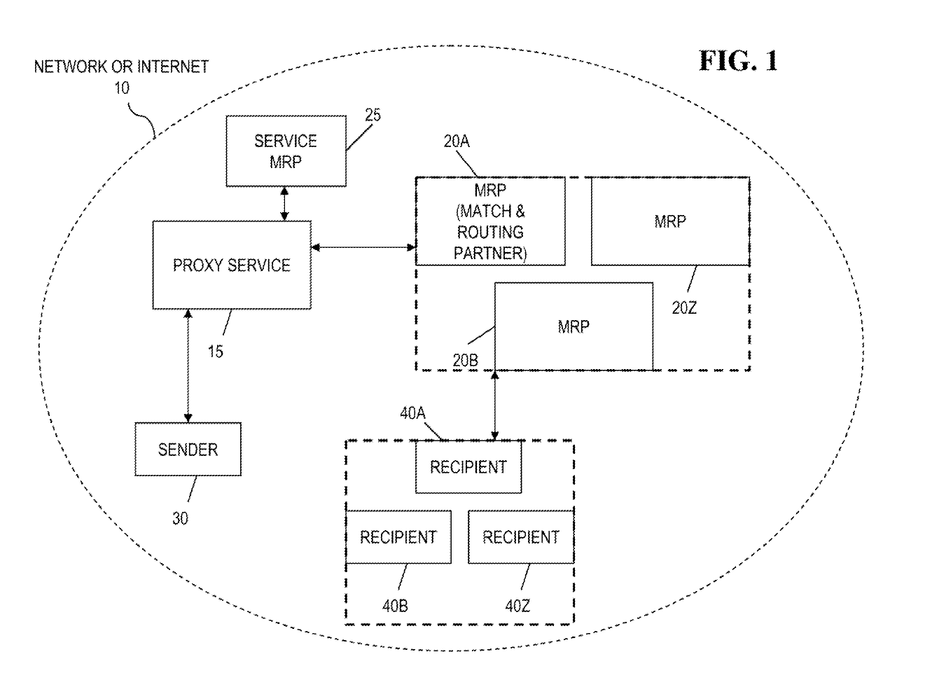

FIG. 1 illustrates an exemplary network environment of the preferred embodiments. Shown are the various interacting elements of the preferred embodiments. Central to the scheme is the proxy service 15, which communicates through the Internet (or other network type) 10 with other parties within the network 10. The preferred embodiment is presented to enable one skilled in the art to make and use the invention.

The proxy service 15 is embodied in a central computer system, which may include one or more, computers, servers, databases, etc. With the proxy service 15, a message can be sent to an intended recipient's 40 email address without any knowledge of the recipient's email address. For purposes of illustration, only one example sender terminal 30, and three identical recipient terminals, i.e., 40A, 40B and 40Z are specifically shown. The reference number 40 will be used to refer to a typical recipient or collectively to several recipients. Further, for purpose of illustration, three identical MRP's are shown, i.e., 20A, 20B and 20Z. The reference number 20 will be used to refer to a typical MRP or collectively to several MRPs. It should be noted that the system could be interconnected with any number of senders, recipients and MRPs. The proxy service 15 utilizes novel proxy technologies and collaborates with third party providers 20 (MRPs) that maintain privy knowledge of email addresses. The proxy service 15 preferably adheres to the following principles:
1. Email should only be seen by its intended recipient 40.
2. If an email cannot be delivered, a “delivery failure” kind of message should be sent to the sender 30.
3. Privacy laws and policies should be maintained.

The proxy service 15 is preferably deployed over a computer network such as the Internet 10. The proxy service 15 is implemented in an automated fashion using conventional computers, servers, programs, programming languages and databases to perform the various tasks and functions outlined below. The MRPs 20 likewise perform their tasks using computers, servers and databases in communication with the proxy service 15. The recipients' 40 and senders' 30 client computers generally communicate with the proxy service 15 over a network connection by utilizing client software, such as a web browser and/or email client. The various entities involved communicate with each other through the network 10.

Definitions:

The following terms as used in this specification have the following meaning:
1. Sender 30—the sender of a message.
2. Recipient 40—a recipient or potential recipient of a message.
3. Proxy service 15—acts as an email routing service that receives messages from senders 30 and routes them to the correct recipients 40.
4. Match and Routing Providers (MRPs 20)—Partners of the proxy service 15 that are used to match recipients' 40 non-email attributes to the recipients' 40 email addresses, and route notifications to such recipients 40.
5. Service MRP 25—A special MRP that uses mapping information accumulated during service operation. Except for its knowledge, which comes from the proxy service 15 operations, it acts identically to a “standard” MRP 20.
6. Email Hash Code—A hash code generated for an email address. Other “one way functions” may also be used in lieu of a hash code.
   Match and Routing Providers:

Many organizations require registration to their services. During registration, the registrant provides multiple personal attributes, such as a phone number, email address, street address, social security number, bank account number, and more. Examples for such organizations are e-commerce sites, ISPs, phone companies, government offices, credit card companies, instant messaging providers, etc.

Such user information is usually stored in the organization's database, but cannot be exported or shared with other entities due to strict privacy laws and policies. Each MRP 20 may be an independent organization, such as a business, which collects information from each of its various users or clients, and maintains such information in a database on the MRP's 20 servers. It should be noted that one or more MRPs 20 may be affiliated with the proxy service 15 and may be controlled by the same entity, in which case the operations of the MRP 20 may occur within the same computer system as the proxy service 15.

Some MRPs 20 may be willing to provide some attributes about their registrants to the proxy service 15, while others may not be willing to export any such information.

How the Proxy Service 15 Works:

Step 1: Preferably the proxy service 15 requires a sender 30 to register with the proxy service 15 before providing access to its email routing functions. The proxy service 15 may require registration as a means of verifying the identity of the sender 30, which may assist the proxy service 15 in monitoring and preventing abuse of the proxy service 15. The registration process may require the sender 30 to fill in a number of data fields with personal information.

Step 2: After registering with the proxy service 15, the sender 30 may submit a message to the proxy service 15 for further routing by using standard techniques, such as the following exemplary embodiments. In one embodiment, the message is sent to the proxy service 15 by using a phantom email address, which contains the non-email attribute as part of the email address. For example, when phone numbers are used as the non-email attribute, the address may appear as: “+1234567890@EmailRouting.com”. In this example, the recipient's 40 phone number is (123)-456-7890.

In another embodiment, the recipient's 40 non-email attribute is included in the subject line of the email message sent to the proxy service 15. The non-email attribute is preferably demarcated within the subject line by using brackets, enabling the proxy service 15 to identify it as a non-email attribute. The proxy service 15 will then remove the non-email attribute from the subject line when it is forwarded to the recipient 40.

In another embodiment the message is entered by the sender 30 using a web-based interface at the proxy service's 15 website. The sender 30 first logs in to the website using a unique ID and password. The sender 30 may then submit a message via the interface by filling in various fields, including the sender's 30 name, subject line, message, recipient's 40 name, non-email attribute, and reply email address. The web-based interface may preferably display a one time verification code to be submitted back to the proxy service 15 by the sender 30. This verification code will be preferably conveyed to the sender 30 in a machine unreadable form, e.g. a series of random letters and digits in a scribbled bitmap image, in order to make it difficult for OCRs to decipher the embedded text. This may be useful in determining that the sender 30 is a human, and not an automated sending agent. The proxy service 15 may also provide an option for mass email marketing. Email marketers may submit a list of non-email attributes of recipients 40 to the proxy service 15 along with a message to be relayed to all recipients 40. The proxy service 15 may charge for this service on a per recipient basis, or under another pricing model.

The sender 30 sending the message with the non-email attributes does not know at the time he sends the message whether the proxy service 15 will successfully route the message to the recipient. Depending on the amount of participating MRP's 20, the chances of success increases.

Step 3: When the proxy service 15 receives a message from the sender 30 containing a non-email attribute (having been submitted using one of the above methods), it identifies the non-email attribute of the recipient 40. The proxy service 15 then queries the different MRP's 20 in order to find a match for the non-email attribute preferably using one of the following three options. Preferably, a query ID is associated with the query, and the query ID is conveyed to each MRP 20 that is being queried. The query ID is used to identify the particular query during interaction between the proxy service 15 and the MRPs 20.

Option 1: Some MRPs 20 may be subject to strict privacy policies or laws that may not allow them to export any information to the proxy service 15. In this case the proxy service 15 will send a query containing the non-email attribute of the recipient 40 to a server associated with each MRP 20. Each MRP 20 that receives the non-email attribute over the network will automatically query its database of records for the non-email attribute and will determine whether it could be mapped to an email address. If it finds no matching records (that match the non-email attribute, e.g. phone number, and also have a filled-in email address field), it reports “no match” to the proxy service 15. If it finds one or more matches, it replies to the proxy service 15 with a list containing the Email Hash Code of each of these matches (or any other “one way” function of the email address, as long as the same “one way” function is used by all MRPs 20). The list of the Email Hash Codes reported to the proxy service 15 may include other information relative to each Email Hash Code, such as the freshness of the information associated with the Email Hash Code.

Option 2: Some MRPs 20 may be willing to export non-email attribute information to the proxy service 15. In this case each such MRP 20 will periodically update the proxy service 15 with its list of non-email attribute information of records that have associated email addresses (e.g. the list of phone numbers of registrants that also provided their email addresses). The proxy service 15 then looks up this list for matching records and queries the MRP 20 for the list of Email Hash Codes only when one or more matches are found. Each MRP 20 then responds to the proxy service 15 with the Email Hash Codes.

Option 3: Some MRP's 20 may be willing to export both the non-email and email attributes of records maintained in their databases to the proxy service 15. The MRP 20 will periodically update the proxy service 15 with a list of email addresses, which will be maintained at the proxy service's 15 server under a secure and confidential cover. The proxy service 15 in this case, instead of querying the MRP 20 directly, will query the information of the MRP 20 maintained at the servers of the proxy service 15 to determine a match with the non-email attribute of the recipient 40. In this case the proxy service 15 will also perform the Routing and Challenge Message processes outlined below.

The proxy service 15 may also query the service MRP 25 to determine an email address associated with the non-email attribute of the recipient. The service MRP 25 is generally integrated with the proxy service 15, and may share system resources with the proxy service 15, including databases and hardware.

In other embodiments, the MRP's 20 provide the proxy service 15 with the actual email addresses instead of the Email Hash Codes, in which case the following steps are performed with a list of email addresses in lieu of a list of Email Hash Codes.

Step 4: If no matching email address is found at any of the MRPs 20 the proxy service 15 will respond to the sender 30 with a delivery failure message. The response may be submitted to the sender 30 by email, or in the event the email message was submitted via a web interface, the delivery failure may be reported back the sender 30 via the web.

Step 5: If one or more matches are found then the proxy service 15 collects all the Email Hash Codes (or email addresses, in the cases where the actual email addresses are submitted in lieu of the Email Hash Codes) that were submitted by MRPs 20. In the case of Option 3 (above in Step 3), the proxy service 15 will generate an Email Hash Code for all matching email address that were determined using Option 3. A list of all Email Hash Codes with the corresponding MRP 20 is generated for all matching results. The proxy service 15 may also obtain for each Email Hash Code, date information associated with the email address, which may indicate the freshness of the corresponding MRP's 20 information.

Step 6: The proxy service 15 then checks if there are any duplicate Email Hash Codes. Duplicate Email Hash Codes are preferably removed. The proxy service 15 may include criteria as to which of the duplicate Email Hash Codes to retain based on the goodness of the corresponding MRPs 20. Further, the proxy service 15 may choose to retain only Email Hash Codes of more credible MRPs 20, or only Email Hash Codes corresponding to more recently updated information. After removing the duplicate and/or undesired Email Hash Codes the proxy service 15 sends a notification to all the MRPs 20 of the remaining Email Hash Codes to proceed with the Challenge Message of Step 7. The proxy service 15 provides each MRP 20 with the same non-email attribute used in the query process, as well as the Email Hash Code. The MRP 20 retrieves the correct email address by repeating its part of the query process and selecting the email address(es) having an equal Email Hash Code. Alternatively, the query ID associated with the query helps the MRP identify the particular email address.

Step 7: Challenge Message: The MRP's 20 that receive the notification of Step 6, send a special Challenge Message to the email address represented by the Email Hash Code. Thus, the recipient may receive several such messages from different MRP's 20, in the case there are several MRP's 20 that have found a match with the non-email attribute provided by the sender 30. However, if several MRP's 20 have found a match with the same email address, then preferably only one MRP is instructed to send the Challenge Message.

The purposes of the Challenge Message are: (1) To notify the recipient 40 that there is a message waiting for him/her. (2) To invite the recipient 40 to “unlock” the message by authenticating his non-email attributes used by the message sender 30.

The Challenge Message will contain: (1) Optionally, proxy service 15 descriptions and authentication instructions. (2) Preferably, a one time code (“Code”) which will have to be reported back to the proxy service 15 by the recipient 40. This Code is preferably conveyed in a machine unreadable form, e.g. a series of random letters and digits in a scribbled bitmap image, in order to make it difficult for OCRs to decipher the embedded text. (3) A hint about the non-email attribute used by the sender 30. The hint should not allow a person receiving the email (other than the intended recipient 40) to understand what the value of the non-email attribute was, but it should contain enough information for the intended recipient 40 to figure it out. For example, if the recipient's 40 phone number was used, it could be one of many phone numbers the recipient 40 owns. In this case the hint can be the last 3-4 digits of the phone number, or the phone number with every other digit replaced with an asterisk. (4) Request that the recipient 40 takes some action to authenticate his/her non-email attribute+any any information required to take the action (e.g. click a URL to the proxy service's 15 authentication server).

Step 8: Recipient Authentication: Preferably the proxy service 15 requires the use of an authentication method, such as one of the following examples. The purpose of all methods is to make sure that the responder to the Challenge Message is the intended recipient 40 of the sender's 30 message, i.e. the one that “owns” the non-email attribute, e.g. the phone number.

Method 1: Simple authentication scheme: the responder is considered authentic if he/she provides the proxy service 15 with the Code and the non-email attribute used by the sender 30. For example, the Challenge Message may contain a URL to the proxy service's 15 authentication server with identification of the sender's 30 message. The recipient 40 of the Challenge Message clicks on the URL to open the authentication page. On the authentication page, he/she will have to enter the Code and the full phone number (that the last 3-4 digits of which may be provided as a “hint”). The advantage is that it is universal, i.e. works for any type of non-email attribute.

The simple authentication scheme may also be used for phone number authentication (alone or together with other authentication methods), e.g. when the phone number is a business number containing an extension, so caller-ID based schemes cannot guarantee uniqueness.

Method 2: Phone number authentication: this method may be used when the non-email attribute used is the recipient's 40 phone number. It may be implemented as follows: (a) recipient-originated: the Challenge Message asks the recipient 40 to call a certain service number from the phone number that was provided by the sender 30 as the non-email attribute of the recipient 40. This number will be validated using Caller ID. The Code can be optionally keyed in using the recipient's 40 telephone; or (b) proxy service-originated: the Challenge Message includes a URL that the recipient 40 navigates to when sitting by the phone whose number was used by the sender 30 as the recipient's 40 non-email attribute. The proxy service 15 then calls the number. The recipient 40 will be asked by the IVR (Interactive Voice Response system) to key in the Code.

In both versions, upon successful authentication an IVR system will ask the recipient 40 to use a URL provided in the Challenge Message in order to retrieve the sender's 30 email message. It can optionally read a Retrieval Code to the authenticated recipient 40. This Retrieval Code will then have to be typed on the proxy service 15 website in order to retrieve the message.

Step 9: The user receiving the Challenge Message authenticates his non-email attribute used by the sender 30. Upon successful authentication: (a) The recipient 40 can retrieve the sender's 30 message in any conceivable way, e.g. viewing it on the proxy service's 15 Web site, have the proxy service 15 forward the message to his/her email address, etc. (b) A “successful delivery” message is sent to the sender 30. (c) If the recipient 40 provides his email address to the proxy service 15 (e.g. for forwarding the sender's 30 message), the proxy service 15 may store the pair (sender-provided non-email attribute, recipient-provided email address) in the service MRP 25 database, in order to use this information for relaying future email messages.

Step 10: Deadline option: if no successful authentication is received by some deadline, the proxy service 15 discards the waiting email message and notifies the sender 30.

The proxy service 15 may preferably be marketed to end-users through affiliate websites. For example, a Yellow Pages website may feature a link next to each business listing that would enable sending an email to the business using the routing functions of the proxy service 15.

It will be apparent to one of ordinary skill in the art that aspects of the invention, as described above, may be implemented in many different forms of software, firmware, and hardware for the implementations described. The actual software code or specialized control hardware used to implement aspects consistent with the principles of the invention is not limiting of the present invention. Thus, the operation and behavior of the aspects were described without reference to the specific software code—it being understood that one of ordinary skill in the art would be able to design software and control hardware to implement the aspects based on the description herein.

The invention has been described herein in the context of a preferred embodiment. It would be apparent to one skilled in the art that some of the steps and techniques described above for implementing the preferred embodiment may be omitted or replaced by other techniques without departing from the spirit and scope of the invention. Various modifications to the preferred embodiment described herein will be readily apparent to those skilled in the art, and general principles defined herein may be applied to other embodiments and applications without departing from the spirit and scope of the invention. The present invention is not intended to be limited to the embodiment shown, but is to be accorded the widest scope consistent with the appended claims.

Appended to this specification are one or more claims, which include both independent claims and dependent claims. Each dependent claim refers to a previous claim, and should be construed to incorporate by reference all the limitations of the previous claim to which it refers. Further, each dependent claim of the present application should be construed and attributed meaning as having at least one additional limitation or element not present in the claim to which it refers. In other words, the claim to which each dependent claim refers is to be construed and attributed meaning as being broader than such dependent claim.

1. A computerized method for sending a message to an email address of a recipient by using a non-email attribute of the recipient, the computerized method comprising:
receiving at a computer the message including the non-email attribute of the recipient and not including the email address of the recipient;
sending the non-email attribute of the recipient to a plurality of partner servers, wherein each partner server maintains a plurality of email addresses and one or more non-email attributes associated with each email address;
identifying in at least one of the partner servers the email address of the recipient, the email address of the recipient being associated with the non-email attribute of the recipient; and
sending by the at least one of the partner servers to the email address of the recipient an email message including instructions for retrieving the message.
